(19) United States
(12) Patent Application Publication
(10) Pub. No.: US 2010/0219061 A1
(43) Pub. Date: Sep. 2, 2010

(54) ENHANCEMENT OF ACID GAS ENRICHMENT PROCESS

(75) Inventors: Abdulwahed Al Utaibi, Reading (GB); Waleed R. Al Khateeb, Reading (GB)

Correspondence Address: BRACEWELL & GIULIANI LLP, P.O. BOX 61389, HOUSTON, TX, 77208-1389, US

(73) Assignee: SAUDI ARABIAN OIL COMPANY, Dhahran (SA)

(21) Appl. No.: 12/396,307

(22) Filed: Mar. 2, 2009

(51) Int. Cl. B01D 3/16; B01D 53/14

(52) U.S. Cl. 203/42; 95/199; 96/104

(57) ABSTRACT

An improved process for the removal and recovery of sulfur from a sour hydrocarbon stream is provided. The process includes contacting a sour hydrocarbon stream that includes hydrogen sulfide and carbon dioxide with a lean absorbent to produce a rich absorbent stream. The rich absorbent stream is separated and the recovered acid gas is contacted with a second absorbent to produce a second rich absorbent stream. A portion of the second rich absorbent is recycled to the separation step. A second portion of the second rich absorbent is separated to produce an acid gas product stream. Recycling a portion of the second rich absorbent to the first separation step shifts the equilibrium of the process, resulting in an acid gas product stream having an increased hydrogen sulfide:carbon dioxide ratio.

### BACKGROUND OF THE INVENTION

1. Technical Field of the Invention

This invention generally relates to the field of upgrading hydrocarbons. In particular, the present invention is directed to a method and apparatus for enhancing the removal and recovery of sulfur from a sour hydrocarbon feed.

2. Description of the Prior Art

Petroleum based products, particularly oil and gas products, frequently contain significant quantities of hydrogen sulfide (H₂S) and carbon dioxide (CO₂), in addition to the desired hydrocarbons. Removal of impurities is typically required before the hydrocarbons can be further processed.

Natural gas used by consumers is composed mainly of methane, and can also include other light hydrocarbon gases, such as for example, ethane, propane and butanes. In addition, natural gas typically can include impurities, such as for example, water vapor, hydrogen sulfide, carbon dioxide, helium, and nitrogen. Natural gas must be conditioned to remove impurities to meet commercial hydrocarbon and moisture specifications, prior to sale or further processing. Typically, commercial specifications require hydrogen sulfide content of no greater than 4 ppm by volume and a moisture content of no greater than 7 lbs/MMscf (pounds per million standard cubic feet). Carbon dioxide concentration is typically limited to less than 2% by volume. Processes within oil refineries or natural gas processing plants that remove hydrogen sulfide and/or mercaptans are commonly referred to as sweetening processes. These processes are named such because the resulting products no longer have the sour, foul odors or mercaptans and hydrogen sulfide.

Hydrogen sulfide and carbon dioxide that are removed from hydrocarbons as acid gases have separate individual commercial value. For example, hydrogen sulfide which is recovered from hydrocarbon streams can be converted to sulfur for use in various manufacturing processes. Carbon dioxide can be used in the miscible flooding of oil reservoirs for enhanced oil recovery.

Hydrogen sulfide removed from hydrocarbon streams is typically converted to elemental sulfur in a sulfur recovery process unit. Total sulfur recovery yields of the recovery unit are dependent on the concentration of the hydrogen sulfide supplied to the sulfur recovery unit. Thus, there is a need to enhance the gas feed to the sulfur recovery unit to maximize elemental sulfur recovery.

### SUMMARY OF THE INVENTION

Provided are a method and apparatus for enhancing sulfur recovery from a sour hydrocarbon feed. Specifically, the method and apparatus are directed to enhancing the hydrogen sulfide:carbon dioxide molar ratio in an acid gas stream prior to the acid gas stream being provided to a sulfur recovery unit.

In one aspect, a method for enhancing sulfur recovery from a sour hydrocarbon stream is provided. The method includes a first absorption step, first regeneration step, a second absorption step and a second regeneration step. The first absorption step includes contacting a hydrocarbon feed, wherein the hydrocarbon feed includes a hydrocarbon, carbon dioxide and hydrogen sulfide, with a first absorbent solvent stream to generate a hydrocarbon product stream lean in hydrogen sulfide and a first rich absorbent solvent stream that includes hydrogen sulfide and carbon dioxide. The first regeneration step includes separating the first rich absorbent solvent stream into a first recycle absorbent solvent stream and a first acid gas stream, wherein the first acid gas stream includes hydrogen sulfide and carbon dioxide. The second absorption step includes contacting the first acid gas stream with a second absorbent solvent stream to generate a carbon dioxide stream and a second rich absorbent solvent stream includes hydrogen sulfide and carbon dioxide. The second rich absorbent solvent stream is separated into a first portion and a second portion. The second regeneration step includes separating the first portion of the second rich absorbent solvent stream into a second recycle absorbent solvent stream and a second acid gas stream, wherein the second acid gas stream includes hydrogen sulfide and carbon dioxide. The first and second recycle absorbent solvent streams are supplied to the first and second absorption steps and the second portion of the second rich absorbent solvent stream is recycled and combined with the first rich absorbent solvent stream and supplied to the first regeneration step.

In another embodiment, up to about 50% (volume percent) of the second rich absorbent solvent stream is recycled and combined with the first rich absorbent solvent stream and supplied to the to the first regeneration step. In one embodiment, between about 20 and 35% (volume percent) of the second rich absorbent solvent stream is recycled and combined with the first rich absorbent solvent stream and supplied to the to the first regeneration step. In certain embodiments, during the second absorption step, at least half of the carbon dioxide in the first acid gas stream is separated and removed in the carbon dioxide stream. In certain other embodiments, at least 70% (mole percent) of the carbon dioxide present in the first acid gas stream is separated and removed in the carbon dioxide stream.

In another aspect, an apparatus for enhancing the sulfur recovery from a sour hydrocarbon stream is provided. The apparatus includes a first absorption column, a first separation column, a second absorption column and a second separation column. The first absorption column includes a sour hydrocarbon stream inlet, a lean absorbent stream inlet, a hydrocarbon stream outlet and a rich amine stream outlet. The hydrocarbon stream outlet is located at the top of the first absorption column and the rich absorbent stream outlet is located at the bottom of the first absorption column. The sour hydrocarbon stream inlet and the lean absorbent stream inlet are arranged such that the sour hydrocarbon feed stream contacts the lean absorbent stream within the first absorption column. The first separation column includes a rich absorbent stream inlet, a first acid gas outlet and a lean absorbent stream outlet. The second absorption column includes a first acid gas inlet, a lean absorbent stream inlet, a carbon dioxide outlet and a rich absorbent stream outlet. The second separation column includes a rich absorbent stream inlet, a second acid gas outlet and a lean absorbent stream outlet. A first line connects the rich absorbent stream outlet of the first absorption column and rich absorbent stream inlet of the first separation column. A second line connects the acid gas outlet of the first separation column and the acid gas inlet of the second absorption column. A third line connects the rich absorbent stream outlet of the second absorption column and the rich absorbent stream inlet of the second separation column. The third line includes a valving arrangement, wherein the valving arrangement is designed to divert a portion of the second rich absorbent stream. A fourth line connects the valving arrangement and the first line, wherein the connection includes a mixer for combining two fluid streams. A fifth line connects the lean absorbent outlet of the first separation column and the lean absorbent inlets of the first and second contacting columns. A sixth line connects the lean absorbent stream outlet of the second separation column and the lean absorbent stream inlet of the second contacting column. The fifth line also includes a valving arrangement, wherein the valving arrangement capable of diverting a portion of the fifth line to the lean absorbent stream inlet of the second contacting column.

In certain embodiments, the apparatus for enhancing the sulfur recovery from a sour hydrocarbon stream can further include a first reflux loop coupled to the acid gas outlet of the first separation column, wherein the first reflux loop operates to provide a purified acid gas stream and a reflux recycle stream, wherein the purified acid gas stream is supplied via a sour gas line to the inlet of the second absorption column and the reflux recycle stream is resupplied to the first separation column. The apparatus can also include a second reflux loop coupled to the acid gas outlet of the second separation column, wherein the second reflux loop operates to provide a purified acid gas product stream and a reflux recycle stream, wherein said purified acid gas stream is collected as an acid gas product stream and the reflux recycle stream is resupplied to the second separation column.

### BRIEF DESCRIPTION OF THE DRAWINGS

FIG. 1 illustrates one exemplary embodiment for the enhancement of sulfur recovery.

FIG. 2 illustrates another exemplary embodiment for the enhancement of sulfur recovery.

FIG. 3 illustrate an exemplary embodiment of a comparative example for the enhancement of sulfur recovery.

### DETAILED DESCRIPTION OF THE INVENTION

The present invention is directed to a method and apparatus for the enhanced recovery of elemental sulfur from a sour hydrocarbon feed. Specifically, a method and apparatus are provided which increase the hydrogen sulfide:carbon dioxide ratio in acid gas prior to being supplied to a sulfur recovery unit. The increased ratio of hydrogen sulfide provides for increased recovery of elemental sulfur.

Hydrocarbon gases that include hydrogen sulfide, or both hydrogen sulfide and carbon dioxide, are referred to as sour gases. Prior to sale of natural gas to consumers, the levels of hydrogen sulfide, moisture and carbon dioxide present in the natural gas must be reduced below acceptable levels. The hydrogen sulfide recovered from natural gas can be further processed to provide elemental sulfur, which can then be used in a variety of manufacturing processes. Accordingly, the present invention provides an apparatus and process for the enhanced recovery of elemental sulfur from hydrocarbon gas streams.

The present invention employs a two step amine gas treatment process. Typically, an amine treatment process includes a single absorption unit and a single regeneration unit, in addition to any required accessory equipment. In contrast, the present invention employs two amine treatment process units arranged in series. Thus, the present invention employs a total of two absorption units (hereinafter referred to as the first and second absorption units) and two regeneration units (hereinafter referred to as the first and second regeneration units).

Typically, in an amine gas treatment process, an aqueous amine absorbent is supplied to the top of the absorption unit and the feed gas is supplied to the bottom of the absorption unit. The upflowing feed gas, which includes hydrogen sulfide and carbon dioxide, is contacted with a downflowing aqueous amine solution to produce a sweetened upflowing hydrocarbon gas stream and an amine solution that is rich in adsorbed acid gases (hereinafter referred to as a rich amine stream). The rich amine stream is then supplied to the regeneration unit where the absorbed gases are stripped from the amine to produce a lean amine bottom stream and an overhead acid gas that includes hydrogen sulfide and carbon dioxide. The lean amine from the regeneration unit can then be recycled to the absorption unit.

In the present invention, the acid gas stream from the first regeneration unit is then supplied as the feed to the second absorption unit. The second absorption unit is configured to remove a substantial portion of the carbon dioxide present in the acid gas feed from the first regeneration unit. Typically, the absorbent is selected such that hydrogen sulfide is preferentially adsorbed and carbon dioxide and other gases are allowed to slip past the absorbent and exit the absorption column with the hydrocarbons. The second absorption unit produces a second rich absorbent stream which is then separated into two portions. A first portion of the rich absorbent stream is supplied to the second regeneration unit, and the second portion of the rich absorbent stream is recycled to the first regeneration unit where it is combined with the rich absorbent stream from the first column. Because the second absorption unit is configured to remove a substantial portion of the carbon dioxide, the resulting rich absorbent stream from the second absorption unit has an increased concentration of hydrogen sulfide relative to the rich absorbent stream from the first absorption unit. Thus, the step of recycling the second portion of the rich absorbent stream to the first regeneration unit changes the equilibrium of the entire process, resulting in an acid gas product collected from the second regeneration unit that has a higher hydrogen sulfide:carbon dioxide ratio than would occur without the recycle of the second rich absorbent stream to the first regeneration unit.

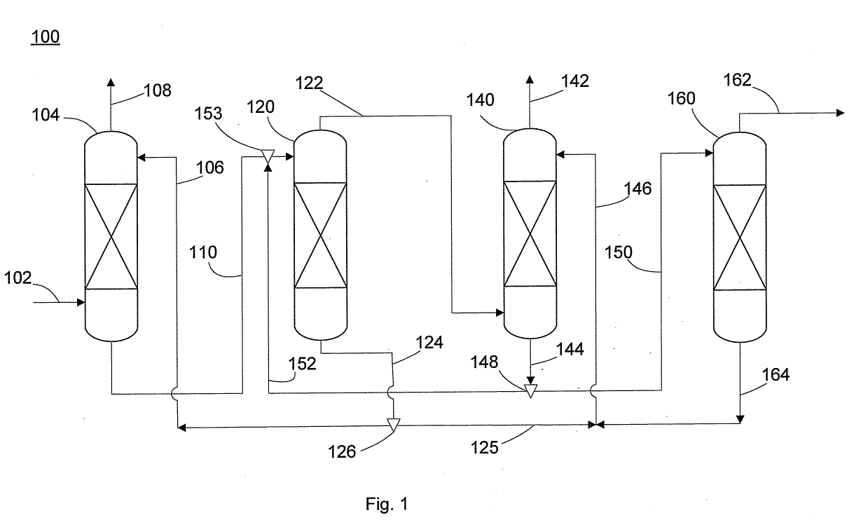

FIG. 1 provides an apparatus 100 for the enhanced recovery of elemental sulfur from a sour hydrocarbon feed stream. A sour hydrocarbon feed 102 that includes both hydrogen sulfide and carbon dioxide is supplied to first absorption column 104 where the sour hydrocarbon feed is contacted with first absorbent solvent stream 106, which includes an absorbent compound for the removal of hydrogen sulfide and carbon dioxide. The first absorption column 104 can include a plurality of stages, trays or the equivalent to increase contact time between the sour hydrocarbon feed and the absorbent stream. In certain embodiments, the sour hydrocarbon feed 102 is an upflowing gas and the absorbent is a downflowing aqueous solution, which contact in a counter-current flow. In certain embodiments, the sour hydrocarbon feed 102 is supplied to the bottom of the first absorption column and the absorbent is supplied to the top of the first absorption column.

In certain embodiments, the absorbent compound is a liquid amine that absorbs both hydrogen sulfide and carbon dioxide present in the hydrocarbon feed. In certain preferred embodiments, the absorbent employed is an aqueous amine. In certain embodiments, the absorbent can be selected from monoethanolamine (MEA), diethanolamine (DEA), methyldiethanolamine (MDEA), diisopropylamine (DIPA), and diglycolamine (DGA). In certain embodiments, the absorbent is a tertiary amine. In other preferred embodiments, the absorbent has higher selectivity for the removal of hydrogen sulfide than carbon dioxide.

The hydrocarbon product stream 108, having reduced hydrogen sulfide content relative to the sour hydrocarbon feed 102, is collected from the top of first absorption column 104. In certain embodiments, the hydrocarbon product stream collected via line 108 is a gas having a molar fractional content of hydrogen sulfide of less than 0.1%, preferably less than 0.01%, and more preferably less than 0.001%. First rich absorbent solvent stream 110, which includes adsorbed carbon dioxide and hydrogen sulfide, is collected from the bottom of first absorption column 104. In certain embodiments, approximately 20%, 25%, 30%, 35%, 40%, 45% or 50% (molar percent) of the carbon dioxide present in the sour hydrocarbon feed is removed.

First rich absorbent solvent stream 110 is supplied to first separation column 120 for separation of the acid gas components (hydrogen sulfide and carbon dioxide) from the absorbent solvent. First acid gas stream 122, which includes hydrogen sulfide and carbon dioxide, is collected from the top of first separation column 120 and first recycle absorbent solvent stream 124, which has substantially reduced amounts of acid gas components, is collected from the bottom of the first separation column. In certain embodiments, at least about 95%, preferably at least about 98%, of the absorbent in the first absorbent solvent stream 106 is recovered in the first recycle absorbent solvent stream 124. First acid gas stream 122 is supplied to a second absorption column 140, while first recycle absorbent solvent stream 124 is recycled back to first absorption column 104 via first absorbent solvent stream 106.

First acid gas stream 122 is supplied to the second absorption column 140 where it is contacted with second absorbent solvent stream 146 to selectively separate carbon dioxide and hydrogen sulfide. A portion of the carbon dioxide present is collected from the top of second absorption column 140 via line 142, and second rich absorbent solvent stream 144, which includes hydrogen sulfide and carbon dioxide, is collected from the bottom of the second absorption column. In certain embodiments, approximately 25% (molar) of the carbon dioxide is removed from first acid gas stream 122. In certain other embodiments, approximately 20%, 30%, 40%, 50% or 60% or higher of the carbon dioxide is removed from first acid gas stream 122. In yet other embodiments, approximately 70% of the carbon dioxide is removed from first acid gas stream 122.

Second rich absorbent solvent stream 144 is supplied to valving arrangement 148, which divides the stream into two portions. A first portion of second rich absorbent solvent stream 144 is supplied via line 150 to second separation column 160, while a second portion of the second rich absorbent solvent stream is supplied via line 152 to piping arrangement or mixer or piping arrangement 153, where it is combined with first rich absorbent solvent stream 110 and supplied to first separation column 120. In certain embodiments, at least approximately 20% of the second absorbent solvent stream 144 is recycled to the first separation column 120. In other embodiments, at least approximately 30% of the second rich absorbent solvent stream 144 is recycled to the first separation column 120. In yet other embodiments, at least approximately 40% of the second rich absorbent solvent stream 144 is recycled to the first separation column 120.

The first portion of the second rich absorbent solvent stream is supplied via line 150 to second separation column 160 where it is separated into second acid gas product stream 162 and second recycle absorbent solvent stream 164, which has substantially reduced amounts of hydrogen sulfide and carbon dioxide. The second recycle absorbent solvent stream 164 is combined with a portion of first recycle absorbent solvent stream 124 and can be recycled to second absorption column 140. Second acid gas product stream 162, having an increased hydrogen sulfide:carbon dioxide ratio relative to both the hydrocarbon feed and first acid gas stream 122, can be collected or supplied to a sulfur recovery unit (not shown).

Recycling the second portion of the second rich absorbent solvent stream 144 to the first separation column 120 results in an increase of the hydrogen sulfide:carbon dioxide ratio, when compared to a process wherein the second portion of the second rich absorbent solvent stream is not recycled to the first separation column. In certain embodiments, recycling a portion of the second rich absorbent solvent stream results in an increase of hydrogen sulfide:carbon dioxide ratio of approximately 10%, 20%, 30%, 40% and preferably 50% or higher, as compared to processes that do not recycle a portion of the second rich absorbent solvent stream.

Circulation of the various streams throughout the present process can be accomplished with a variety of conventional circulation pumps. Additional components, including but not limited to, valves, heat exchangers, flash distillation columns, and mixers can be added to the apparatus described in FIG. 1.

The Claus process is an exemplary method for the recovery of elemental sulfur from gaseous hydrogen sulfide that has been around for more than 100 years. Typically, gases having a hydrogen sulfide content of at least 25% are required for use in the Claus process. The presence of carbon dioxide, or other gases, in the feed to the Claus unit dilutes the reaction, thereby reducing the overall reaction yield. When the feed to the Claus unit has a hydrogen sulfide content of less than 10%, the recovery of hydrogen sulfide becomes nearly impossible.

The Claus process is divided into two steps: a thermal step and a catalytic step. In the thermal step, a portion of the hydrogen sulfide is oxidized in a combustion reaction to produce sulfur dioxide. In the catalytic step, unreacted hydrogen sulfide reacts with sulfur dioxide to produce elemental sulfur.

The hydrogen sulfide content and the concentration of other combustible components (e.g., hydrocarbons or ammonia) will determine the location where the feed gas is burned. Claus feed gases (i.e., acid gases) having no or small quantities of combustible content other than hydrogen sulfide, are typically burned in lances around the central muffle.

Sufficient air is supplied for the combustion of hydrocarbons and gases containing nitrogen. To ensure a stoichiometric reaction for the Claus process, the flow of air to acid gas combustion is controlled to ensure that about ⅓ of all hydrogen sulfide is converted to sulfur dioxide. Pure oxygen can be supplied to reduce the process gas volume, or to obtain higher combustion temperatures. Typically, between 60-70% of the total elemental sulfur produced in the process is obtained during the thermal process step.

The reaction continues with the catalytic step, wherein remaining hydrogen sulfide reacts with sulfur dioxide formed during the combustion step to form gaseous elemental sulfur. The catalytic recovery process includes three steps, which may be repeated up to three times to increase sulfur yields. Typically, a Claus unit having two catalytic process steps can recover approximately 97% of the sulfur supplied to the unit. The feed gases, which include hydrogen sulfide and sulfur dioxide, are heated to a pre-determined temperature to prevent sulfur condensation in the catalyst bed. Typically, the process gases are heated in a reheater to achieve the desired temperatures.

Typical operating temperatures of the first catalytic stage are between 300° C. and 400° C. Subsequent catalytic stages have reduced operating temperatures, as catalytic conversion is maximized at lower temperatures. Operating temperatures are preferably maintained above the dew point of sulfur to prevent condensation in the catalytic bed, which can lead to fouling of the catalyst.

The tail gas from the Claus process contains combustible components and sulfur containing components, and can be burned in an incineration unit or further desulfurized. The sulfur which is recovered from a Claus process is collected and can be used for various manufacturing processes, including sulfuric acid, medicines, cosmetics, fertilizers and rubber products.

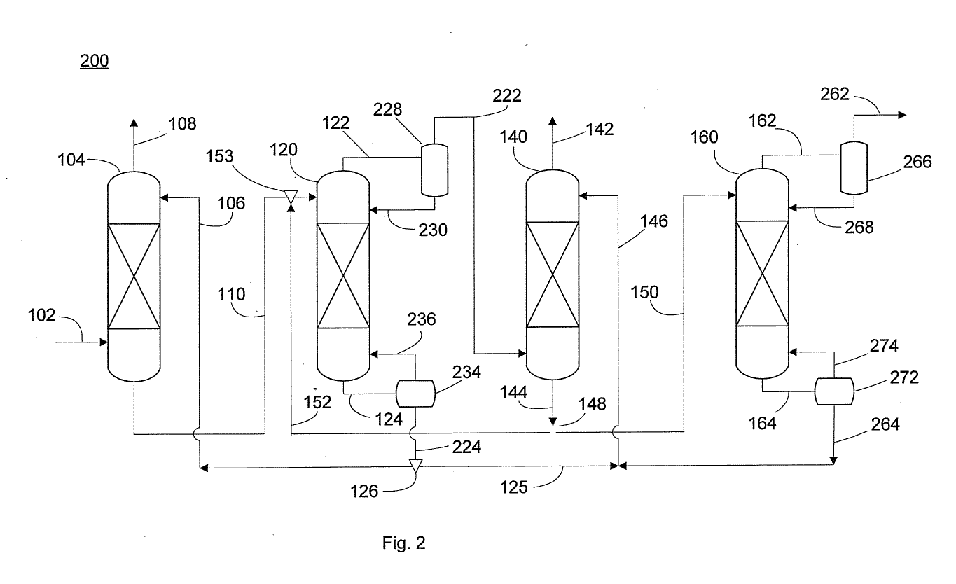

FIG. 2 shows a second exemplary apparatus 200 for the enhanced recovery of elemental sulfur from a sour hydrocarbon feed. Sour hydrocarbon feed 102 is supplied to first absorption column 104 where the sour hydrocarbon feed is combined with first absorbent solvent stream 106, which includes an absorbent compound, preferably a liquid amine, which adsorbs both hydrogen sulfide and carbon dioxide that are present in the sour hydrocarbon feed. First absorption column 104 can include trays, packing or the equivalent to increase contact between the hydrocarbon feed and the absorbent stream. A hydrocarbon product stream 108, having reduced hydrogen sulfide content relative to the sour hydrocarbon feed, is collected from the top of first absorption column 104. First rich absorbent solvent stream 110, which includes carbon dioxide and hydrogen sulfide, is collected from the bottom of first absorption column 104.

First rich absorbent solvent stream 110 is supplied to first separation column 120 for separation of the acid gas components (hydrogen sulfide and carbon dioxide) from the absorbent solvent stream. First acid gas stream 122, which includes hydrogen sulfide and carbon dioxide, is collected from the top of first separation column 120. The first acid gas stream 122 is supplied to a reflux column 228 which removes a substantial portion of the water from the acid gas stream. Water is collected from the bottom of reflux column 228 and is recycled to first separation column 120 via line 230. A first acid gas stream 222, having reduced water content, is collected from reflux column 228 and supplied to second absorption column 140. First recycle absorbent solvent stream 124, which has substantially reduced amounts of acid gas components relative to the feed to first separation column 120, is collected from the bottom of the first separation column via line 124. The first recycle absorbent solvent stream 124 is supplied to reboiler 234, which ensures that any hydrogen sulfide or carbon dioxide present in first recycle absorbent solvent stream 124 is resupplied to first separation column 120 via line 236. The first recycle absorbent solvent stream is collected from reboiler 234 via line 224 and supplied to valving arrangement 126. Valving arrangement 126 separates recycle stream 238 into two portions, recycling a first portion of the first recycle absorbent solvent stream 106 to first absorption column 104 and a second portion of the first recycle absorbent solvent stream 125 to second absorption column 140 via line 146.

First acid gas stream 222 is supplied to the second absorption column 140 where it contacts second absorbent solvent stream 146 to selectively separate carbon dioxide and hydrogen sulfide. A portion of the carbon dioxide is collected from the top of absorption column 140 as carbon dioxide stream 142. Second rich absorbent solvent stream 144, which includes hydrogen sulfide and carbon dioxide, is collected from the bottom of the absorption column 140. Second rich absorbent solvent stream 144 is supplied to splitter or valving arrangement 148, which that separates the stream into two portions. A first portion of second rich absorbent solvent stream 144 is supplied via line 150 to second separation column 160, while a second portion of the second rich absorbent solvent stream is supplied via line 152 to mixer or piping arrangement 153, where it is combined with first rich absorbent solvent stream 110 and supplied to first separation column 120.

The first portion of the first rich absorbent solvent stream is supplied via line 150 to second separation column 160 where it is separated into second acid gas product stream 162 and second recycle absorbent solvent stream 164, which has substantially reduced amounts of acid gas components. The second recycle absorbent solvent stream 164 is combined with the second portion of the first recycle absorbent solvent stream 125 and can be recycled to second absorption column 140. Second acid gas stream 162, which includes hydrogen sulfide and carbon dioxide, is collected from the top of second separation column 160. The second acid gas stream 162 is supplied to a reflux column 266 which removes a substantial portion of the water from the acid gas stream. Water is collected from the bottom of reflux column 266 and is recycled to second separation column 160 via line 268. Second acid gas stream 162, having reduced water content, is collected from reflux column 266 and supplied to second absorption column 160. Second gas product stream 262, having an increased hydrogen sulfide:carbon dioxide ratio relative to both the hydrocarbon feed and acid gas stream 222, can be collected or supplied to a sulfur recovery unit.

The second recycle absorbent solvent stream 164 is supplied to reboiler 272, which ensures that any hydrogen sulfide or carbon dioxide present in second recycle absorbent solvent stream 164 is resupplied to second separation column 160 via line 274. The second recycle absorbent solvent stream 264 is collected from reboiler 272 via line 264 and supplied to second absorption column 140 via line 146.

It is understood that the exemplary figures and processes provided herein can include other components which are not illustrated, such as for example, valves, heat exchangers, flash tanks, filtration devices, wash water, pumps and mixers. Additionally, it is understood that one or more make-up streams can be added to the process to supply fresh absorbent to replace the absorbent that is lost during the various separation and absorption stages.

While the exemplary processes have been described with respect to the use of amine absorbents, it is understood that other non-amine liquid absorbents that are selective for the removal of hydrogen sulfide and carbon dioxide can also be used.

### COMPARATIVE EXAMPLES

The calculations for the comparative examples were carried out by employing the process simulator ProMax® (version 2.0). This simulator is provided by BRE Houston (USA) and is considered the industry standard for the purposes of designing amine based acid gas removal process plants typically installed in oil refinery and natural gas plant applications. ProMax® is a recent version of TSWEET®, which has been employed extensively in the industry. In addition to employing the customary laboratory measured physical property data, TSWEET® has been augmented by incorporating performance data from actual plant operations and is therefore considered to be highly reliable for design purposes. The circulating solvent is typically a 50% by weight aqueous solution of methyl diethanolamine containing a promoter. The rich amine loadings have been set at 0.3 to 0.5 moles of acid gas per mole of circulating amine. The approach to equilibrium for the rich amine at the bottom of the contactor columns has been limited to not greater than 75%. The reflux ratio in the stripper columns are in the range of 0.9 to 1.8. This operating data has been used as typical examples but operation outside of these ranges is also possible.

### Comparative Example 1

Comparative Example 1 provides an exemplary apparatus and method for the separation and removal of acid gases from a sour hydrocarbon feed featuring a recycle of a rich amine stream from a second absorption unit to the first separation unit, to upgrade the acid gas feed to a sulfur recovery unit. Reference to FIG. 1 is made for Comparative Example 1. The hydrogen sulfide:carbon dioxide ratio of the resulting acid gas is compared with the hydrogen sulfide:carbon dioxide ratio of a process not employing a recycle step.

A sour hydrocarbon feed that includes (by molar fraction) approximately 80% methane, 8.5% carbon dioxide, 7% nitrogen, 2% hydrogen sulfide and 1% ethane is supplied in gaseous form to a first absorption column where the gas contacts an absorbent stream that includes MDEA and water. The hydrogen sulfide:carbon dioxide ratio of the initial feed is approximately 0.25.

A hydrocarbon product stream which includes methane, ethane, carbon dioxide and nitrogen, and only trace amounts of hydrogen sulfide is collected from the top of the first absorption column. The hydrocarbon product stream includes approximately 99% of the methane supplied to the first absorption column, as well as approximately 100% of the nitrogen, 100% of the ethane, and 47% of the carbon dioxide supplied to the first absorption column. The rich absorbent, which includes hydrogen sulfide and carbon dioxide, has a ratio of approximately 0.46.

The rich absorbent from the first absorption column is supplied to a first separation column for separation of carbon dioxide and hydrogen sulfide from the MDEA. The feed to the first separation column includes water, MDEA, carbon dioxide and hydrogen sulfide, and is combined with a portion of the rich absorbent stream from a second absorption column, wherein the ratio of hydrogen sulfide:carbon dioxide in the feed to the first separation column is approximately 0.6. The first separation column separates the acid gas from the MDEA absorbent, providing a first acid gas stream that includes water, carbon dioxide and hydrogen sulfide and a bottoms stream that includes water and MDEA. The bottoms stream from the first separation column is recycled and supplies absorbent to the first absorption column and the second absorption column.

The acid gas stream from the first separation column, having a hydrogen sulfide:carbon dioxide ratio of approximately 0.6, is supplied to a second contacting column where it is contacted with an absorbent stream that includes MDEA and water. The second absorption column removes approximately 73% of the carbon dioxide from the acid gas stream, resulting in a carbon dioxide gas stream which includes less than 0.25% of the hydrogen sulfide supplied to the second absorption column. A bottoms stream is collected, which includes MDEA, water, carbon dioxide and hydrogen sulfide, wherein the hydrogen sulfide:carbon dioxide ratio is approximately 2.21.

The bottoms stream from the second absorption column is supplied to a splitter or valving arrangement, which splits the flow into a first portion and a second portion. The first portion, which includes approximately 28.5% of the acid gas stream, is recycled to the first absorption column. The second portion, which includes approximately 71.5% of the acid gas stream, is supplied to the second separation column. The second separation column separates the MDEA and water from the hydrogen sulfide and carbon dioxide present in the rich absorbent stream, to produce an acid gas stream. The acid gas stream includes approximately 10.5% water, 27.9% carbon dioxide and 61.6% hydrogen sulfide, and has a hydrogen sulfide:carbon dioxide ratio of approximately 2.21.

### Comparative Example 2

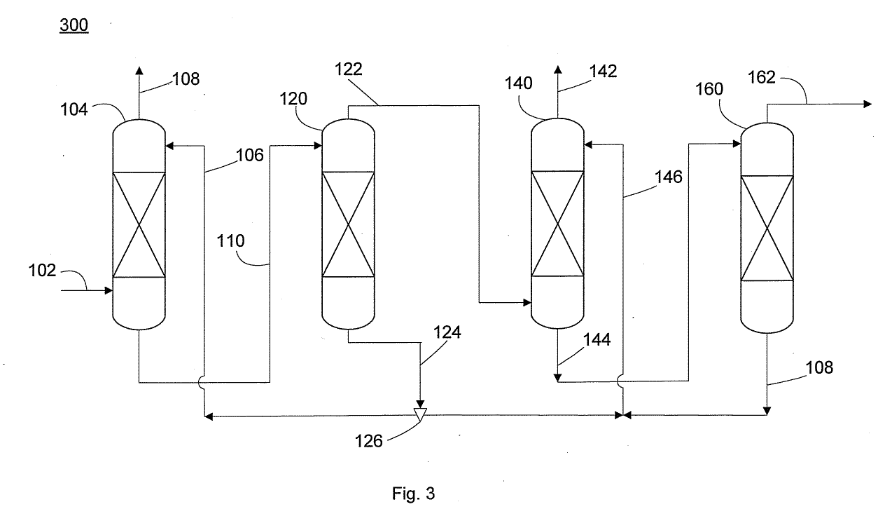

Comparative Example 2 provides an identical apparatus as provided in Comparative Example 1, but differs in that the rich amine stream from a second absorption unit is not recycled to the first separation unit. As shown in FIG. 3, where like reference numbers to FIG. 1 are used, recycle line 152 is absent.

A sour hydrocarbon feed 102 having the same content as Comparative Example 1 (by molar fraction, approximately 80% methane, 8.5% carbon dioxide, 7% nitrogen, 2% hydrogen sulfide and 1% ethane) is supplied first absorption column 104 and contacted with absorbent stream 106, which includes MDEA and water. The hydrogen sulfide:carbon dioxide ratio of the initial feed is approximately 0.25. A hydrocarbon product stream 108 is collected from the top of first contacting column 104. Rich absorbent stream 110, which includes hydrogen sulfide and carbon dioxide, has a hydrogen sulfide:carbon dioxide ratio of approximately 0.46.

The rich absorbent 110 from the first absorption column 104 is supplied to a first separation column 120. The feed includes water, MDEA, carbon dioxide and hydrogen sulfide, and the ratio of hydrogen sulfide:carbon dioxide in the feed is approximately 0.46. The first separation column 120 separates the acid gas from the MDEA absorbent, providing a first acid gas stream 122 that includes water, carbon dioxide and hydrogen sulfide and a bottoms stream 124 that includes water and MDEA.

The first acid gas stream 122, having a hydrogen sulfide:carbon dioxide ratio of approximately 0.46, is supplied to a second absorption column 140 where it is contacted an absorbent stream 146 that includes MDEA and water. The second absorption column 140 removes approximately 73% of the carbon dioxide from the acid gas stream 122, resulting in a carbon dioxide gas stream which includes less than 0.25% of the hydrogen sulfide supplied to the second contacting column. A bottoms stream 144 is collected, which includes MDEA, water, carbon dioxide and hydrogen sulfide, wherein the hydrogen sulfide:carbon dioxide ratio is approximately 1.49.

The bottoms stream 144 from the second absorption column 140 is supplied to second separation column 160 to produce an acid gas product stream 162 includes approximately 10.5% water, 27.9% carbon dioxide and 61.6% hydrogen sulfide, and has a hydrogen sulfide:carbon dioxide ratio of approximately 1.49.

As shown in Table 1, recycle of approximately 30% of the rich absorbent stream from the second absorption column results in an increase of approximately 30% in the hydrogen sulfide:carbon dioxide ratio of the feed to the first separation column 120. This then results in an increase in the hydrogen sulfide:carbon dioxide ratio of approximately 50% in the resulting acid gas product stream.

TABLE 1

| | Comparative | Comparative |
|---|---|---|
| | Example 1 | Example 2 |
| | (with recycle) | (without recycle) |
| H₂S:CO₂ in Hydrocarbon Feed | 0.25 | 0.25 |
| H₂S:CO₂ after First Absorption | 0.46 | 0.46 |
| Column | | |
| H₂S:CO₂ Feed to First Separation | 0.60 | 0.46 |
| Column | | |
| H₂S:CO₂ after Second Absorption | 2.21 | 1.49 |
| Column | | |

Furthermore, recitation of the term about and approximately with respect to a range of values should be interpreted to include both the upper and lower end of the recited range. As used herein, the terms first, second, third and the like should be interpreted to uniquely identify elements and do not imply or restrict to any particular sequencing of elements or steps.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A method for enhancing sulfur recovery from a sour hydrocarbon feed 102, the sour hydrocarbon feed 102 including hydrogen sulfide and carbon dioxide, comprising the steps of:
contacting the sour hydrocarbon feed 102 with a first absorbent solvent stream 106 to generate a hydrocarbon product stream 108 lean in hydrogen sulfide and a first rich absorbent solvent stream 110 comprising hydrogen sulfide and carbon dioxide in a first absorption step;
separating the first rich absorbent solvent stream 110 into a first recycle absorbent solvent stream 124 and a first acid gas stream 122 in a first regeneration step in a first separation column 120, the first acid gas stream comprising hydrogen sulfide and carbon dioxide;
contacting at least a portion of the first acid gas stream 122 with a second absorbent solvent stream 146 in a second absorption step in a second absorption column 140 to generate a carbon dioxide stream 142 and a second rich absorbent solvent stream 144 comprising hydrogen sulfide and carbon dioxide;
splitting the second rich absorbent solvent stream 144 into a first portion of the second rich absorbent solvent stream 150 and a second portion of the second rich absorbent solvent stream 152; and
separating the first portion of the second rich absorbent solvent stream 150 into a second recycle absorbent solvent stream 164 and a second acid gas stream 162 in a second regeneration step in a second separation column 160, the second acid gas stream 162 comprising hydrogen sulfide and carbon dioxide,
wherein the first recycle absorbent solvent stream 164 is operable to be supplied to the first absorption column 104 and the second absorption column 140
wherein the second recycle absorbent solvent stream is operable to be supplied to the first absorption column 104 and the second absorption column 140; and
wherein the second portion of the second rich absorbent solvent stream 144 is operable to be recycled into first separation column 120 and second separation column 160.

2. The method of claim 1 wherein up to 50% of the second rich absorbent solvent stream 144 is recycled and combined with the first rich absorbent solvent stream 110 and supplied to the first regeneration step.

3. The method of claim 1 wherein up to 50% of the first recycle absorbent solvent stream 124 is recycled and combined with the second recycle absorbent solvent stream 164 and supplied to the first absorption column 104 and the second absorption column 140.

4. The method of claim 1 wherein the absorbent solvent is selected from monoethanolamine, diethanolamine, methyldiethanolamine, diisopropylamine, diglycolamine and combinations of amines and methyldiethanolamine.

5. The method of claim 1 wherein the absorbent solvent is methyldiethanolamine.

6. The method of claim 1 wherein the molar ratio of carbon dioxide to hydrogen sulfide after the second absorption step is at least 50% less than the carbon dioxide to hydrogen sulfide ratio after the first absorption step.

7. The method of claim 1 wherein the molar ratio of carbon dioxide to hydrogen sulfide after the second absorption step is at least 60% less than the carbon dioxide to hydrogen sulfide ratio after the first absorption step.

8. The method of claim 1 wherein the absorption steps and regeneration steps are conducted in distillation towers.

9. The method of claim 1 wherein the second acid gas stream is supplied to a Claus process for the production of elemental sulfur.

10. The method of claim 1 wherein the hydrocarbon feed 102 and the first absorbent solvent 106 are contacted in a counter-current flow.

11. The method of claim 1 wherein the first acid gas stream 122 and the second absorbent solvent 146 are contacted in a counter-current flow.

12. The method of claim 1 wherein the absorbent preferentially adsorbs hydrogen sulfide.

13. The method of claim 1 further comprising recovering the hydrocarbon product stream from a head of a distillation column, wherein the hydrogen sulfide content is less than 4 ppm.

14. The method of claim 1 wherein during the second absorption step at least half of the carbon dioxide present in the first acid gas stream is separated and removed in the carbon dioxide stream.

15. The method of claim 1 wherein during the second absorption step at least 70% of the carbon dioxide present in the first acid gas stream is separated and removed in the carbon dioxide stream.

16. The method of claim 1 wherein the hydrogen sulfide:carbon dioxide molar ratio is at least 2.

17. The method of claim 1 wherein the hydrogen sulfide:carbon dioxide molar ratio is at least 2.5.

18. An apparatus for enhancing the sulfur recovery from a sour hydrocarbon stream 102, the hydrocarbon stream including hydrogen sulfide and carbon dioxide, comprising:
a first absorption column 104, said first absorption column having a sour hydrocarbon stream inlet, a lean absorbent stream inlet, a hydrocarbon stream outlet and a rich absorbent stream outlet, wherein said hydrocarbon stream outlet is located at the top of the first absorption column 104 and the rich absorbent stream outlet is located at the bottom of the first absorption column, and wherein said sour hydrocarbon stream inlet and said lean absorbent stream inlet are arranged such that the sour hydrocarbon feed stream 102 contacts the lean absorbent stream 106 within the first absorption column;
a first separation column 120, said first separation column 120 having a rich absorbent stream inlet, a first acid gas outlet and a lean absorbent stream outlet;
a second absorption column 140, said second absorption column 140 having a first acid gas inlet, a lean absorbent stream inlet, a carbon dioxide outlet and a rich absorbent stream outlet,
a second separation column 160, said second separation column 160 having a rich absorbent stream inlet, a second acid gas outlet and a lean absorbent stream outlet;
a first line 110, said first line 110 connecting the rich absorbent stream outlet of the first absorption column and rich absorbent stream inlet of the first separation column;
a second line 122, said second line 122 connecting the first acid gas outlet of the first separation column 120 and the acid gas inlet of the second absorption column 140;
a third line 150, said third line 150 connecting the rich absorbent stream outlet of the second absorption column 140 and said rich absorbent stream inlet of the second separation column 160, wherein said third line 150 includes a splitter or valving arrangement 148, wherein said splitter or valving arrangement 148 is designed to divert a portion of the rich absorbent stream;
a fourth line 152, said fourth line 152 connecting the splitter or valving arrangement 148 and the first line 110, said connection including a mixer or piping arrangement for combining two fluid streams;
a fifth line 124, said fifth line 124 connecting the lean absorbent outlet of the first separation column 120 and the lean absorbent inlets of the first and second absorption columns 104, 140; and
a sixth line 164, said sixth line 164 connecting the lean absorbent stream outlet of the second separation column 160 and the lean absorbent stream inlet of the second absorption column 140;
wherein the fifth line 124 comprises a second splitter or valving arrangement 126, said second or valving arrangement splitter 126 capable of diverting a portion of the fifth line 124 to the lean absorbent stream inlet of the second absorption column 140.

19. The apparatus of claim 18 further comprising:
a first reflux loop 228 coupled to the acid gas outlet of the first separation column 120, wherein said first reflux loop operates to provide a purified acid gas stream and a reflux recycle stream, wherein said purified acid gas stream is supplied via a acid gas line to the inlet of the second absorption column and the reflux recycle stream is resupplied to the first separation column; and
a second reflux loop 266 coupled to the acid gas outlet of the second separation column 160, wherein said second reflux loop operates to provide a purified acid gas product stream and a reflux recycle stream, wherein said purified acid gas stream is collected as an acid gas product stream and the reflux recycle stream is resupplied to the second separation column.

20. The apparatus of claim 18 further comprising an acid gas processing unit, wherein the acid gas product stream is coupled to an inlet of an acid gas processing unit.

21. The apparatus of claim 20 wherein said acid gas processing unit is a Claus unit, said Claus unit being operable for the production of elemental sulfur.
